(19) United States
(12) Patent Application Publication
(10) Pub. No.: US 2019/0199408 A1
(43) Pub. Date: Jun. 27, 2019

(54) ANTENNA SYSTEM FOR AN INTEGRATED POINT OF SALE (POS) MOBILE DEVICE

(71) Applicants: Faisal Saeed, San Jose, CA (US); Zia Hasnain, San Jose, CA (US); Asif Rao, San Jose, CA (US)

(72) Inventors: Faisal Saeed, San Jose, CA (US); Zia Hasnain, San Jose, CA (US); Asif Rao, San Jose, CA (US)

(21) Appl. No.: 16/178,558

(22) Filed: Nov. 1, 2018

Related U.S. Application Data
(63) Continuation-in-part of application No. 15/618,122, filed on Jun. 9, 2017, now Pat. No. 10,140,609.
Application No. 15/618,122 is a continuation-in-part of application No. 14/850,943, filed on Sep. 10, 2015, now Pat. No. 10,127,538.
(60) Provisional application No. 62/580,291, filed on Nov. 1, 2017.
(60) Provisional application No. 62/438,468, filed on Dec. 23, 2016.

(51) Int. Cl. H04B 7/0413; G06K 7/08; G07G 1/00; H04M 1/02

(52) U.S. Cl. CPC H04B 7/0413; H04M 1/0202; G07G 1/0018; G06K 7/084

(57) ABSTRACT

An antenna system for the plastic-metal housing of Point of Sale (PoS) integrated transaction mobile device includes a plastic-metal housing integrated into the PoS integrated transaction mobile device; a magnetic stripe reader (MSR) integrated into the transaction mobile device; a set of metal portions of the antenna system integrated into the plastic-metal housing, wherein the set of metal portions are separated into five metal pieces, wherein the five-metal piece antenna system comprises: a top left antenna of the five-metal piece antenna system housed in a top left portion of an MSR slot of the MSR; a top middle antenna of the five-metal piece antenna system housed in a middle portion of the MSR slot; a top right antenna of the five-metal piece antenna system housed in a top right MSR corner portion of the MSR slot; a bottom middle housing antenna of the five-metal piece antenna system housed in the bottom middle housing of the PoS integrated transaction mobile device; and bottom left slot middle housing antenna integrated into bottom left middle housing portion of PoS integrated transaction mobile device.

### CROSS-REFERENCE TO RELATED APPLICATIONS

This application claims priority to U.S. application Ser. No. 14/850,943, titled Smart Integrated Point-of-sale System and filed on Sep. 10, 2015. This utility application is hereby incorporated by reference in its entirety. This application incorporates by reference in its entirety U.S. Provisional Patent Application No. 62/438,468, titled POINT OF SALE MOBILE DEVICE METHODS AND SYSTEMS and filed on 23 Dec. 2016.

This application incorporates by reference in its entirety U.S. Provisional Patent Application No. 62/580,291, titled METHOD AND SYSTEM OF PAYMENT DEVICE WITH A CAMERA METHOD FOR FRAUD REDUCTION IN CASHLESS TRANSACTIONS and filed on 1 Nov. 2017.

### BACKGROUND

### 1. Field

This description relates to the field of mobile devices and more specifically to an antenna system for a sale integrated transaction mobile device.

### 2. Related Art

Currently in the market there are only products which incorporate payment methods (e.g. MSR, EMV, NFC, etc.) in a jacket/sleeve designed to fit consumer phones such as iPhone. Similar sleeves are also available for scanner. Other companies have a scanner built with a cellular phone, However, this scanner looks like an external scanner. None of these products have a thickness less than fourteen millimeters (14 mm). Additionally, Current PoS systems on the market are bulky, take up large amounts of valuable countertop space, utilize outdated technology, consist of multiple separate attachments, and do not offer a modern look and feel. Moreover, current systems that have some modern look are not capable of accepting all forms of payments, and they are not able to provide valuable user experiences for customers, shop owners, and businesses. Therefore, there is a need to provide a complete end-to-end business management solution that comprises different hardware and software components to provide an integrated payment and customer experience solution.

### BRIEF SUMMARY OF THE INVENTION

In one example aspect, An antenna system for the plastic-metal housing of Point of Sale (PoS) integrated transaction mobile device includes a plastic-metal housing integrated into the PoS integrated transaction mobile device; a magnetic stripe reader (MSR) integrated into the transaction mobile device; a set of metal portions of the antenna system integrated into the plastic-metal housing, wherein the set of metal portions are separated into five metal pieces, wherein the five-metal piece antenna system comprises: a top left antenna of the five-metal piece antenna system housed in a top left portion of an MSR slot of the MSR; a top middle antenna of the five-metal piece antenna system housed in a middle portion of the MSR slot; a top right antenna of the five-metal piece antenna system housed in a top right MSR corner portion of the MSR slot; a bottom middle housing antenna of the five-metal piece antenna system housed in the bottom middle housing of the PoS integrated transaction mobile device; and a bottom left slot middle housing antenna integrated into the bottom left middle housing portion of the PoS integrated transaction mobile device; and wherein the five-metal piece antenna system is a multiple-input and multiple-output (MIMO) antenna system, wherein the five metal pieces of the five-metal piece antenna system are housed in a plastic housing within the plastic-metal housing, and wherein the five-metal piece antenna system are electrically broken with a set of specified antenna breaks.

### BRIEF DESCRIPTION OF THE DRAWINGS

The present application can be best understood by reference to the following description taken in conjunction with the accompanying figures, in which like parts may be referred to by like numerals.

FIG. 1 illustrates an example portion of an PoS integrated transaction mobile device, according to some embodiments.

FIG. 2 illustrates an example top left MSR slot corner, according to some embodiments.

FIG. 3 illustrates an example top right MSR slot corner, according to some embodiments.

FIG. 4 illustrates an example antenna break between housing portion, according to some embodiments.

FIG. 5 illustrates an example bottom middle housing portion, according to some embodiments.

FIG. 6 illustrates an example left slot middle housing portion, according to some embodiments.

FIG. 7 illustrates an example of a top middle housing portion, according to some embodiments.

FIG. 8 is an orthogonal bottom view of a point-of-sale integrated transaction mobile device, according to some embodiments.

FIG. 9 is an orthogonal front view of a point-of-sale integrated transaction mobile device, according to some embodiments.

FIG. 10 is an orthogonal left-side view of a point-of-sale integrated transaction mobile device, according to some embodiments.

The Figures described above are a representative set, and are not an exhaustive with respect to embodying the invention.

### DETAILED DESCRIPTION

Disclosed are a system, method, and article of manufacture for an antenna system for an integrated point of sale (POS) mobile device. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

EMV is a technical standard for smart payment cards and for payment terminals and automated teller machines that can accept them.

Magnetic stripe reader (MSR) can be a device used to read magnetic stripe cards such as credit cards.

Mobile device can be a computing device has an operating system (OS) that can run various types of application software. A mobile device can be equipped with Wi-Fi, Bluetooth, NFC and GPS capabilities that can allow connections to the Internet and other devices, such as an automobile or can be used to provide location-based services. A camera or media player feature for video or music files can also be typically found on these devices along with a stable battery power source such as a lithium battery. A mobile device can also contain sensors like accelerometers, compasses, magnetometers, or gyroscopes, allowing detection of orientation and motion.

Near Field Communication (NFC) is a short-range wireless connectivity standard (e.g. Ecma-340, ISO/IEC 18092) that uses magnetic field induction to enable communication between devices when they're touched together, or brought within a few centimeters of each other.

Personal identification number (PIN) is a numeric password used to authenticate a user to a system. PINs may be used with banking systems to authenticate the identity of the cardholder.

Pogo pin ca be a device used in electronics to establish a connection between two printed circuit boards. In some examples, a pogo pin takes the form of a slender cylinder containing two sharp, spring-loaded pins. Pressed between two electronic circuits, the sharp points at each end of the pogo pin make secure contacts with the two circuits and thereby connect them together.

Point-of-sale (PoS) can be the time and place where a retail transaction is completed. At the PoS, the merchant can calculate the amount owed by the customer and indicate the amount, and may prepare an invoice for the customer, and indicate the options for the customer to make payment.

Radio-frequency identification (RFID) can use electromagnetic fields to automatically identify and track tags attached to objects. The tags can contain electronically stored information. Passive tags collect energy from a nearby RFID reader's interrogating radio waves. Active tags have a local power source such as a battery and may operate at thousands of meters from the RFID reader.

Systems Overview

Embodiments of the present disclosure are directed to an all-in-one integrated PoS integrated transaction mobile device and its concomitant antenna systems. Generally, PoS integrated transaction mobile device is an electronic mobile device that can be connected to other devices or networks using various protocols such as Bluetooth, NFC, Wi-Fi, 2G/3G/4G, etc.

In some embodiments, PoS integrated transaction mobile device provides an interface to a merchant services backend, a backend system that serves a request by applying pre-defined business logic, a database system to store, retrieve, update, delete transaction information, a data warehouse to manage historic data derived from transaction information and other data management sources, payment backend, and a management console to provide visibility to management to monitor all activities, generate reports, and allow management to manually interact with the all-in-one smart integrated point-of-sale system to update and modify information based on business intelligence and data mining.

PoS integrated transaction mobile device can implement payment methods in a secure manner that passes stringent certification requirements. For example, PoS integrated transaction mobile device can include physical/mechanical protections such as, inter alia: tamper switches, security meshes, etc. PoS integrated transaction mobile device can include various logical protections such as, inter alia: chip level encryption, encrypted card data from all payment methods and/or encrypted communication to the back end. These features are incorporated in a cellular phone form factor in the PoS integrated transaction mobile device. PoS integrated transaction mobile device design has all these protections to be incorporated into the form factor of a cellular phone and provides sleek designs around fourteen millimeters (14 mm) or less in thickness. These and other advantages of the present technology are described herein with reference to the collective drawings.

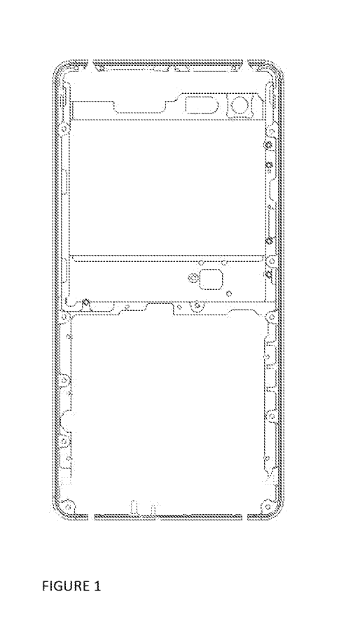

It is noted that different metal sections which are acting as antennas or can act as antennas. For example, FIG. 1 illustrates an example portions 100 of an antenna system of a PoS integrated transaction mobile device, according to some embodiments. Example portions 100 includes the metal portions of the antenna system for the plastic-metal housing of PoS integrated transaction mobile device. Example portions 100 can be separated into five metal pieces shown in 102-110. Example portions 100 includes top left MSR slot corner 102. Example portions 100 includes top middle MSR slot 104. Example portions 100 includes top right MSR corner 106. Example portions 100 includes bottom middle housing 108. Example portions 100 includes left slot middle housing 110. Multiple antennas can be used for MIMO signals. Five metal pieces shown in 102-110 can be housed/held in a plastic housing within PoS integrated transaction mobile device and electrically broken with specified antenna breaks (e.g. as shown infra).

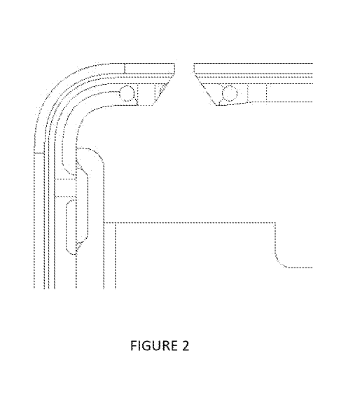

FIG. 2 illustrates an example top left MSR slot corner 200, according to some embodiments. MSR slot corner can be tuned to radiate at different frequencies (e.g. Wi-Fi frequencies, LTE frequencies, GPS frequencies, etc.). Various parameters can be set such as, inter alia: the length to be radiated, which points can be used to excite the antenna, and/or which points can be used to ground the antenna. The lengths can be tuned to radiate at different frequencies. In one example, the lengths of the metal bands available can be nineteen millimeters (19 mm) or seventeen point eight millimeters (17.8 mm). In one example, MSR slot corner parameters can be used to radiate at two-point four giga hertz (2.4 GHz) signals (e.g. corresponds to Wi-Fi frequencies). The metal portions can be non-conductive anodized aluminum. Left MSR slot corner 102 shows areas (e.g. feed point 202, grounding leg 204, etc.) with the aluminum oxide laser-etched off of the aluminum metal to make these areas conductive. The distance (e.g. arc distance, etc.) between these points can be tuned to a harmonic of the targeted signal band. Spring clips on the printed circuit board (PCB) can be used to make contact with the metal at the etched points to catch the signals from the antenna, etc. This technique can be utilized elsewhere on the other metal portions.

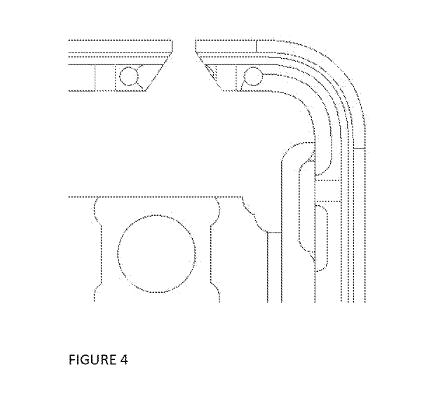

FIG. 3 illustrates an example top right MSR slot corner 300, according to some embodiments. Right Hand Side MSR Slot Corner 300 can share similar characteristics with the left slot corner (e.g. as provided in FIG. 2). Right Hand Side MSR Slot Corner 300 can include a metal piece. The metal piece can be used to radiate at two-point four gigahertz (2.4 GHz) and can be used as a Wi-Fi Antenna in one example embodiment of the PoS integrated transaction mobile device. The length of the curve that that is excited in the top right MSR slot corner 300 can vary between, for example, nineteen point two millimeters (19.2 mm,) eighteen point thirteen millimeters (18.13 mm) and sixteen point forty-three millimeters (16.43 mm). The position of the feed point 304 and grounding point 306 are selected to control the effects of other metal components around the antenna as any metal component in close proximity of the antenna can couple with the antenna and cause it to detune (e.g. radiate as a frequency which is not desired). Top right MSR slot corner 300 can be a mirror image of top left MSR slot corner 200.

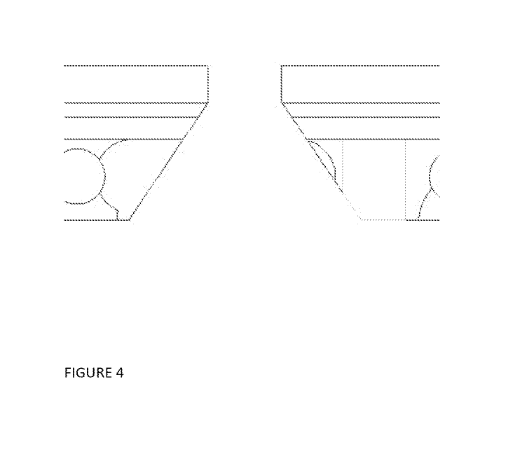

FIG. 4 illustrates an example antenna break 402 between housing, according to some embodiments. The size of the metal antenna break 402 can be small enough to not couple with the metal on the other side of antenna break 402 and radiate as a single piece. Accordingly, antenna break 402 can be set to a two millimeters (2 mm) gap for the break to ensure that the antenna systems performs as an isolated entity and does not couple (e.g. interfere) with the other metal parts. The specific widening shape of antenna break 402 ensures that a minimum of 2 mm gap is maintained in the gap and the characteristics of antenna do not change. Antenna break 402 can enable different portions to radiate as different types of antennas.

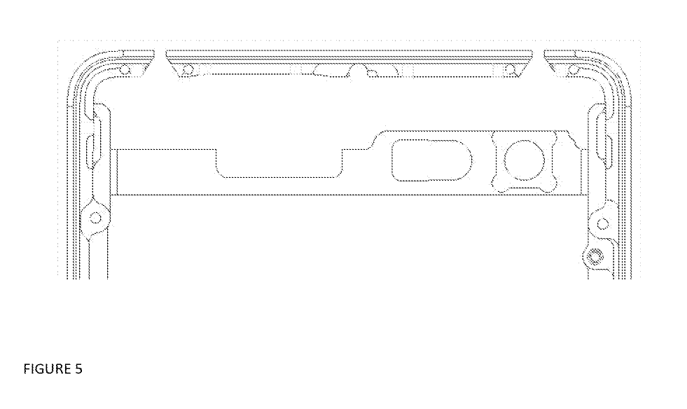

FIG. 5 illustrates an example bottom-middle housing portion 500, according to some embodiments. The bottom-middle housing portion 500 can also be tuned as various frequencies owing to its length. The bottom antenna of bottom-middle housing portion can be tuned to ensure that the speaker box and/or universal serial bus (USB) connector does not detune the respective antenna portion. The speaker can be a floating metal piece which can itself act as an antenna and couple with the metal band in the housing. Accordingly, in one example the speaker can be positioned at least two millimeters (2 mm) away from the metal band bottom-middle housing portion to ensure that there is sufficient gap between the metal parts which in turn ensures they will not interfere when radiating.

The length of the metal band on the bottom can be fifty-eight point one millimeters (58.1 mm). The metal band of bottom-middle housing portion 500 can be tuned this part to radiate at various LTE band frequencies. The feed point for the band can be set fifteen point fifty-five millimeters (15.55 mm) from the left antenna break as shown in the respective figures. Accordingly, this metal band can be used as a Wi-Fi Antenna when the round the band is grounded at twenty-three point three (23.3 mm) from the left antenna break. The gap between for the antenna breaks can be set at two millimeters (2 mm) to ensure there is no coupling. The metal band of bottom-middle housing portion 500 can be thinner is width the metal bands of FIGS. 1-4 in the top portion of PoS integrated transaction mobile device.

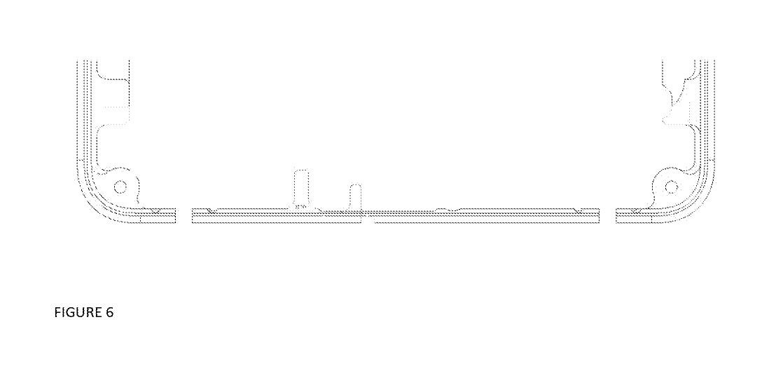

FIG. 6 illustrates an example left slot middle housing portion 600, according to some embodiments. The EMV slot region 602 can also be tuned to radiate at frequencies for GPS and RFID. For example, the length of the slot can be set to fifty-five point five millimeters (55.5 mm). The slot antenna can be fed from any end of the slot of EMV slot region 602. The feed point can be next to the slot in one example. In another example, it can be up to twenty millimeters (20 mm) from the end of the slot. The grounding point can be located on the opposite end of the slot. The grounding point could also be located up to twenty millimeters (20 mm) from the end of the slot. Hence, the radiating slot length could be between fifty-five point five millimeters (55.5 mm) and one-hundred millimeters (100 mm).

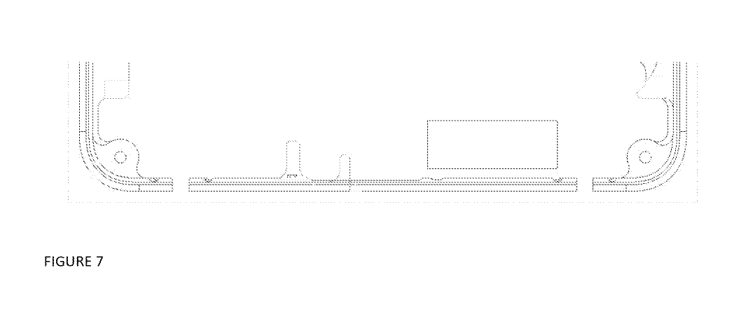

FIG. 7 illustrates an example of a top middle housing portion, according to some embodiments. Owing to the size of top middle MSR slot 700, it can be tuned to radiate at a varied range of frequencies. In one example, the length of top middle MSR slot 700 can be increased to make the antenna radiate at various frequencies used for LTE bands and/or GPS bands. The total length of the radiating metal part can be forty-nine point zero seven millimeters (49.07 mm). In one example, a point can be set at twenty point eighty-nine millimeters (20.89 mm) from the left antenna break. This can enable top middle MSR slot 700 to radiate the entire part into two (2) separate parts. One part can be to the left of the feeding point and the other part can be to the right of the feeding point. The two (2) lengths can radiate thirty-eight-point twenty-one millimeters (38.21 mm) and twenty point eight-nine millimeters (20.89) mm in length. FIG. 7 illustrates etch points 702-714. Pairs of etch points 702-714 can be selected for different antenna lengths to achieve different types of antenna tunings. In this way the antennas can be tuned for multiple uses. The locations of the etchings can also be shifted around to obtain different lengths and thus, varied antenna tunings.

The entire length of top middle MSR slot 700 metal portions can also be tuned to radiate at frequencies which match GPS bands. To achieve this the feed point can be set at twenty point eighty-nine millimeters (20.89 mm) from the left antenna break and the grounding the antenna thirty-eight point ninety-five millimeters (38.95 mm) from the left antenna break.

Example PoS Integrated Transaction Mobile Device

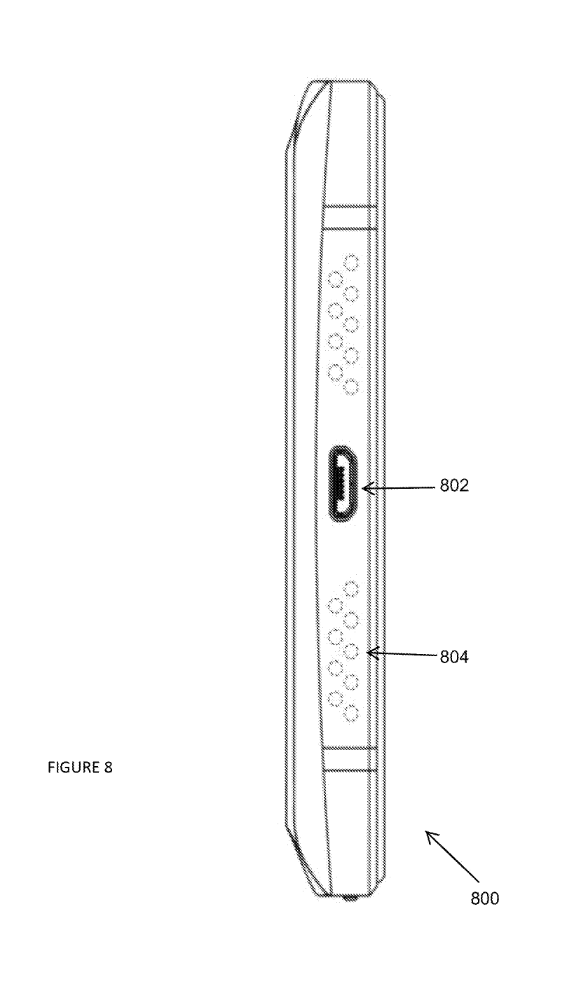

FIGS. 8-10 illustrate various orthogonal views of a PoS integrated transaction mobile device 800. PoS integrated transaction mobile device 800 can include one or more processors (e.g., Intel® Atom® processor or any other tablet processor), a secure payment processor, and a main memory and static memory (collectively “memory”), which communicate with each other and any additional components via a bus.

PoS integrated transaction mobile device 800 may further include display(s), such as merchant display, at least one customer display. PoS integrated transaction mobile device 800 may also include an alpha-numeric or numeric input device(s) (e.g., a keyboard, keypad, touchscreen, numeric keypad), a weighing scale, biometric sensor(s) (e.g., fingerprint, voice recognition, face recognition, etc.), a scanner or barcode reader, at least one camera, and be communicatively coupled with a printer. PoS integrated transaction mobile device 800 can be connected to other devices or networks via Ethernet, Bluetooth Low Energy (BLE), Wi-Fi, Cellular data, such as 2G/3G/4G, and Bluetooth. Additionally, PoS integrated transaction mobile device 800 may include a signature display, a keypad, a magnetic stripe reader (MSR), an EMV (Europay, MasterCard, and Visa) card reader, NFC (Near field communication) reader, a drive unit (also referred to as disk drive unit), audio/microphone, GPS/gyroscope, I/O (Input/Output) Ports Hub, and ports. PoS integrated transaction mobile device 800 may further include a power integrated circuit (IC) that can manage the power supply to various components within PoS integrated transaction mobile device 800 and a data encryption module (not shown) to encrypt data.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, cellular data technologies like LTE, 2G/3G/4G, etc., or an IEEE 802.11-based radio frequency network.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, Customer Relationship Management (CRM) systems, Enterprise Resource Planning (ERP) systems, and the like, which may be utilized in order to implement any of the embodiments of the disclosure as described herein.

The present technology may be implemented as a web service in a secure cloud-based distributed scalable computing environment. A cloud-based computing environment is a resource that typically combines the computational power of a large grouping of processors and/or that combines the storage capacity of a large grouping of computer memories or storage devices sometimes distributed in different continents. For example, systems that provide a cloud resource may be utilized exclusively by their owners; or such systems may be accessible to outside users who deploy applications within the computing infrastructure to obtain the benefit of large computational or storage resources and may provide outside users access to larger audience.

The cloud back-end to support a PoS integrated transaction mobile device 800 may be formed, for example, by a network of web servers, with each web server (or at least a plurality thereof) providing processor and/or storage resources. These servers may manage workloads provided by multiple users (e.g., cloud-resource customers or other users). Typically, each user places workload demands upon the cloud that vary in real-time, sometimes dramatically. The nature and extent of these variations typically depend on the type of business associated with the user.

PoS integrated transaction mobile device 800 can mechanically isolate the payment and scanner functionalities into a separate payment module. The payment module incorporates the security features of PoS integrated transaction mobile device. The payment module design enables a USB connector and/or USB connection through pogo pins. This reduces the size and thickness of the connector.

More specifically, FIG. 8 is a perspective bottom view of PoS integrated transaction mobile device 800, according to some embodiments. PoS integrated transaction mobile device 800 can include speakers 804 and port 802. Port 802 can be a computer bus and/or power connector.

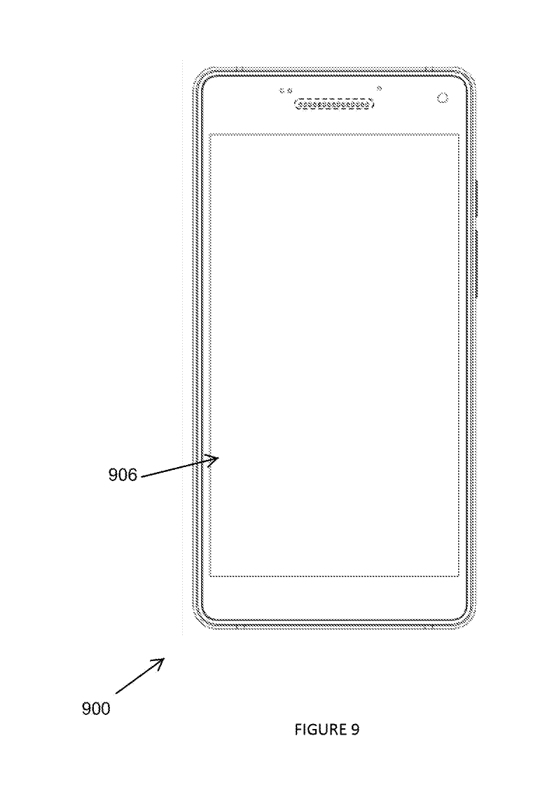

FIG. 9 is a orthogonal front view of PoS integrated transaction mobile device 800, according to some embodiments. PoS integrated transaction mobile device 800 can include touch-screen display 806. Touch-screen display 806 can be an input and output device normally layered on the top of an electronic visual display of an information processing system. A user can give input or control the information processing system through simple or multi-touch gestures by touching the screen with a special stylus and/or one or more fingers. Touch-screen display 806 can be used to access the functionalities of a mobile-device payment application. In this way, PoS integrated transaction mobile device 800 can used to manage payment services operated under financial regulation and performed from or via PoS integrated transaction mobile device 800.

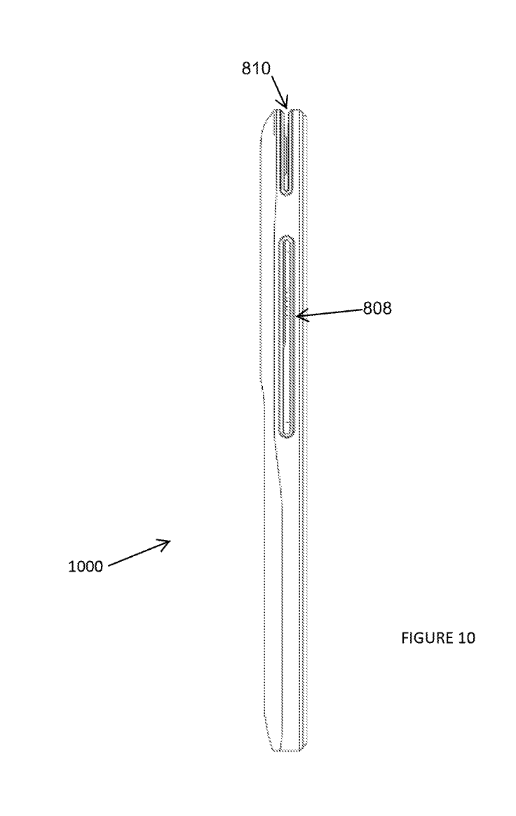

FIG. 10 is a orthogonal left-side view of PoS integrated transaction mobile device 800, according to some embodiments. PoS integrated transaction mobile device 800 can include MSR slot 810. MSR slot 810 can include a magnetic card reader that is a component of a payment module. The dimensions of the slot can be slightly larger than the thickness of a magnetic card (e.g. slightly greater than zero point seventy-six millimeters (0.76 mm) as regulated by ISO/IEC 7810 or other international standards). PoS integrated transaction mobile device 800 can include EMV slot 808. EMV slot 808 can be slight larger than the portion of a credit card to be inserted in its chip reader portion (e.g. as defined by ISO/IEC 7810 or another international standard, etc.). Additional dimensions of various aspects of the payment module, MSR slot 810 and/or EMV slot 808 are provided infra according to some embodiments.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. An antenna system for the plastic-metal housing of Point of Sale (PoS) integrated transaction mobile device comprising:
a plastic-metal housing integrated into the PoS integrated transaction mobile device;
a magnetic stripe reader (MSR) integrated into the transaction mobile device;
a set of metal portions of the antenna system integrated into the plastic-metal housing, wherein the set of metal portions are separated into five metal pieces, wherein the five-metal piece antenna system comprises:
a top left antenna of the five-metal piece antenna system housed in a top left portion of an MSR slot of the MSR;
a top middle antenna of the five-metal piece antenna system housed in a middle portion of the MSR slot;
a top right antenna of the five-metal piece antenna system housed in a top right MSR corner portion of the MSR slot;
a bottom middle housing antenna of the five-metal piece antenna system housed in the bottom middle housing of the PoS integrated transaction mobile device; and
a bottom left slot middle housing antenna integrated into the bottom left middle housing portion of the PoS integrated transaction mobile device; and
wherein the five-metal piece antenna system is a multiple-input and multiple-output (MIMO) antenna system, wherein the five metal pieces of the five-metal piece antenna system are housed in a plastic housing within the plastic-metal housing, and wherein the five-metal piece antenna system are electrically broken with a set of specified antenna breaks.

2. The integrated PoS mobile device of claim 1, wherein the MSR comprises a device used to read magnetic stripe cards such as credit cards.

3. The integrated PoS mobile device of claim 2, wherein the MIMO antenna system comprises an antenna system for multiplying a capacity of a radio link using multiple transmit and receive antennas to exploit a multipath propagation.

4. The integrated PoS mobile device of claim 3, wherein a size of each metal antenna break is set to not interfere with a metal portion on another side of the antenna break.

5. The integrated PoS mobile device of claim 4, wherein each antenna break is set to a two millimeters (2 mm) gap such that the antenna break performs as an isolated entity and does not interfere with the other metal parts of the integrated PoS mobile device.

6. The integrated PoS mobile device of claim 5, wherein each antenna break is shaped to ensures that a minimum of two millimeters (2 mm) gap is maintained in a gap of the antenna break and a set of characteristics of antenna do not change.

7. The integrated PoS mobile device of claim 6, wherein each antenna break is set such that each portions of the five-metal piece antenna system radiates as different type of antenna.

8. The integrated PoS mobile device of claim 6, wherein the integrated PoS mobile device comprises an EMV slot, and wherein the EMV slot comprises an EMV slot antenna.

9. The integrated PoS mobile device of claim 7, wherein the dimensions of the EMV slot antenna are tuned to radiate at a GPS frequency.

10. The integrated PoS mobile device of claim 9, wherein the dimensions of the EMV slot antenna are tuned to radiate at an RFID frequency.

11. The integrated PoS mobile device of claim 10, wherein a length of the EMV slot is set to fifty-five point five millimeters (55.5 mm), and wherein the EMV slot antenna is fed from any end of the EMV slot.

12. The integrated PoS mobile device of claim 10, wherein a feedpoint of the EMV slot antenna is set up to twenty millimeters (20 mm) from an end of the EMV slot, and wherein a grounding point of the EMV slot antenna is located on the opposite end of the EMV slot from the feedpoint.

13. The integrated PoS mobile device of claim 12, wherein a length of a top middle MSR slot is set such that the top middle antenna of the five-metal piece antenna system radiates at a set of frequencies used for LTE bands or GPS bands.

14. The integrated PoS mobile device of claim 13, wherein a total length of a radiating metal part is set to forty-nine point zero seven millimeters (49.07 mm).
